(19) United States
(12) Patent Application Publication
(10) Pub. No.: US 2017/0061347 A1
(43) Pub. Date: Mar. 2, 2017

(54) COMPUTERIZED SYSTEM AND METHOD FOR PREDICTING QUANTITY LEVELS OF A RESOURCE

(71) Applicant: ORACLE FINANCIAL SERVICES SOFTWARE LIMITED, Mumbai (IN)

(72) Inventors: Latha GANESH, Bangalore (IN); Rama Rao MUTTAVARAPU, Telangana (IN); Januelle A. PINTO, Mangalore (IN)

(21) Appl. No.: 15/076,828

(22) Filed: Mar. 22, 2016

(30) Foreign Application Priority Data
Aug. 28, 2015 (IN) 3306/MUM/2015

(51) Int. Cl. G06Q 10/06

(52) U.S. Cl. CPC G06Q 10/06312; G06Q 10/067

(57) ABSTRACT

Systems, methods, and other embodiments associated with a computing device and an assumption engine are described. A computing device includes an input/output port, a memory including instructions stored therein, and a processor. The device generates data records of a resource from a set of contracts that define usage terms for the resource, wherein the data records include quantity levels of the resource that are available in a plurality of time intervals. The device allocates the time intervals to time buckets. The device defines possible events that cause changes to the quantity levels of the resource and applies the possible events to the data records to generate modified quantity levels. A computerized output is generated including a liquidity metric based on, at least in part, the modified quantity levels as a result of applying the set of possible events.

### CROSS REFERENCE TO RELATED APPLICATIONS

This disclosure claims the benefit of Indian Provisional Patent Application serial number “3306/MUM/2015” filed Aug. 28, 2015, titled “Business Assumption Engine For Generating Incremental Cash Flow Or Cash Flow Movement”, inventors: Latha GANESH, Rama Rao MUTTAVARAPU, and Januelle A. PINTO, and assigned to the present assignee, which is incorporated by reference herein in its entirety.

### BACKGROUND

When an organization provides a resource to customers and the resource has a limited quantity, the organization should monitor quantity levels of the resource to properly manage the resource. Monitoring the quantity levels helps to ensure that situations are avoided where the quantity level of the resource drops to a low level. Computerized systems are used to monitor resources but it is difficult to predict future quantity levels, which may be useful to manage and plan the usage of the resource.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a computing device configured with an assumption engine.

FIG. 2 illustrates one embodiment of a method performed by the system of FIG. 1.

FIG. 3 illustrates one embodiment of a screen image of a graphical user interface (UI) for defining an assumption/event including identifying an assumption category and parameters associated with the assumption, which are input to the system of FIG. 1.

FIG. 4 illustrates one embodiment of a screen image of the graphical user interface (UI) for defining a business assumption for an assumption category of “cash flow movement” and parameters associated with the assumption, which are input to the present system.

FIG. 5 illustrates one embodiment of an assumption definition flow diagram that gives an overview of the data flow in generating metadata for the assumptions from FIG. 3 and/or FIG. 4. Attributes of the assumptions are stored as metadata in data structures.

FIG. 6 illustrates one embodiment of a data flow diagram of transformation of the metadata to assumption cash flows generated by the present system.

FIG. 7 illustrates an example special purpose computing device that is configured and/or programmed with one or more of the example systems and methods described herein, and/or equivalents.

### DETAILED DESCRIPTION

Computerized systems and methods are described herein in one embodiment that monitor and control allocation of a resource between computerized data structures based on a set of conditions and/or assumptions about events that may occur in the future. The computerized system is configured to monitor and predict quantity levels of the resource at selected time periods based on one or more possible events that may occur, where the events change the levels of the resource. In one embodiment, the present system implements a computerized interface for defining and generating possible events and conditions that, if the events occur, can change the quantity levels of the resource. The generated events are applied to expected levels of the resource to determine how the expected levels will be affected.

The present system is useful to predict the levels of the resource at selected points in time in order to ensure that an organization maintains a sufficient amount of the resource at any given time period. The present system thus helps the organization determine how to manage and control an inventory level of the resource.

In one embodiment, the resource being controlling is a computerized form of cash flow and the system generates liquidity metrics for an organization in response to various “what if” scenarios that can change levels of cash flow. Liquidity Risk Management (LRM) has emerged as a critical risk management function for banking institutions, as regulators increasingly require banks to have a liquidity management framework in place. As per the Basel Committee on Banking Supervision (BCBS), “liquidity is the ability of a bank to fund increases in assets and meet obligations as they come due, without occurring unacceptable losses.”

Oracle Financial Services Liquidity Risk Management is a computer system designed to address liquidity risk of banking institutions across the world. It helps financial institutions to: drive liquidity ratio regulatory compliance and adhere to tight regulatory deadlines through prepackaged rules and computations; engage in enterprise-wide comprehensive stress testing that feeds into the contingency funding planning process; improve risk reporting practices by leveraging an extensive set of reports and dashboards built out of a unified data model. The present system and method is configured to operate with such risk management systems, in one embodiment.

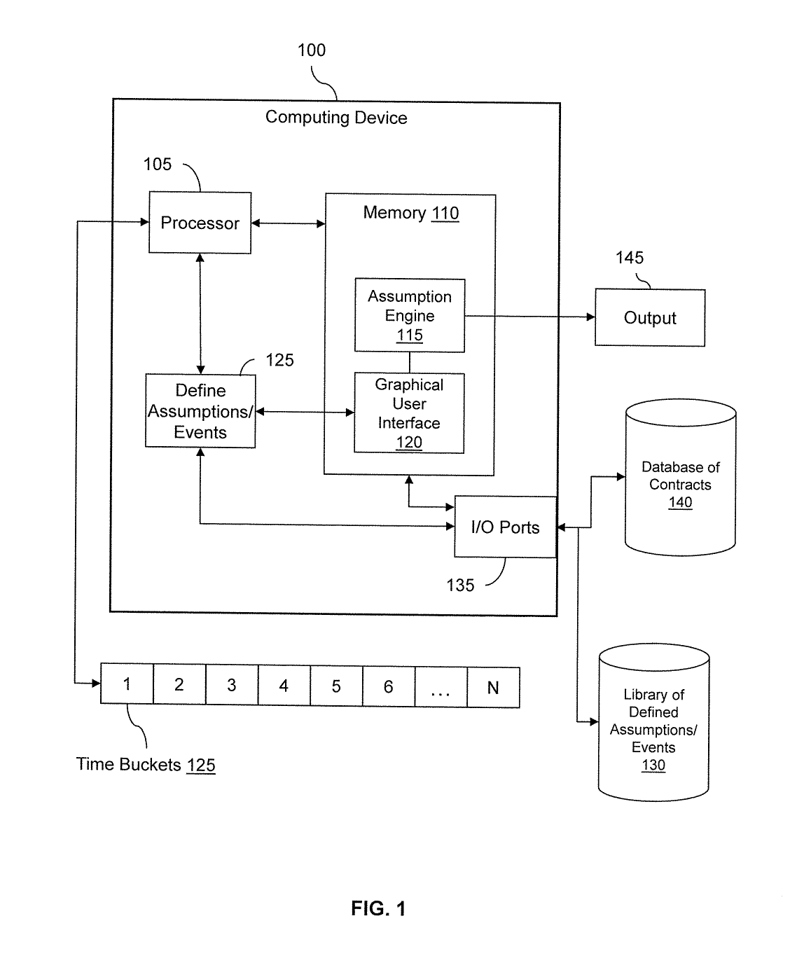

With reference to FIG. 1, one embodiment of a special purpose computing device 100 is shown that is implemented with a system for predicting levels of a resource at selected points in time in response to a variety of possible events. The computing device 100 includes at least a processor 105 and a memory 110 where the processor 105 is configured to execute instructions stored in the memory 110. The computing device 110 includes an assumption engine 115 that is implemented as a computer program product stored in the memory 110 that includes executable instructions that when executed by the processor 105 cause the computing device 100 to perform the functions/algorithms described herein for predicting levels of the resource based on various possible assumptions/events/conditions.

The assumption engine 115 includes a graphical user interface 120 that when executed by the processor 105 generates a graphical user interface on a display screen of the computing device 100. The graphical user interface 120 provides functionally to at least allow a user to define a set of assumptions/conditions/events 125. The defined assumptions 125 can be selected and used by the assumption engine 115 to make predictions of resource levels as described in more detail below. In one embodiment, the defined assumptions 125 are stored in a library of defined assumptions/conditions 130 in a computer storage device. The computing device 100 includes one or more input/output (I/O) ports 135 that transmit and receive network communications to and from other computer components and remote devices.

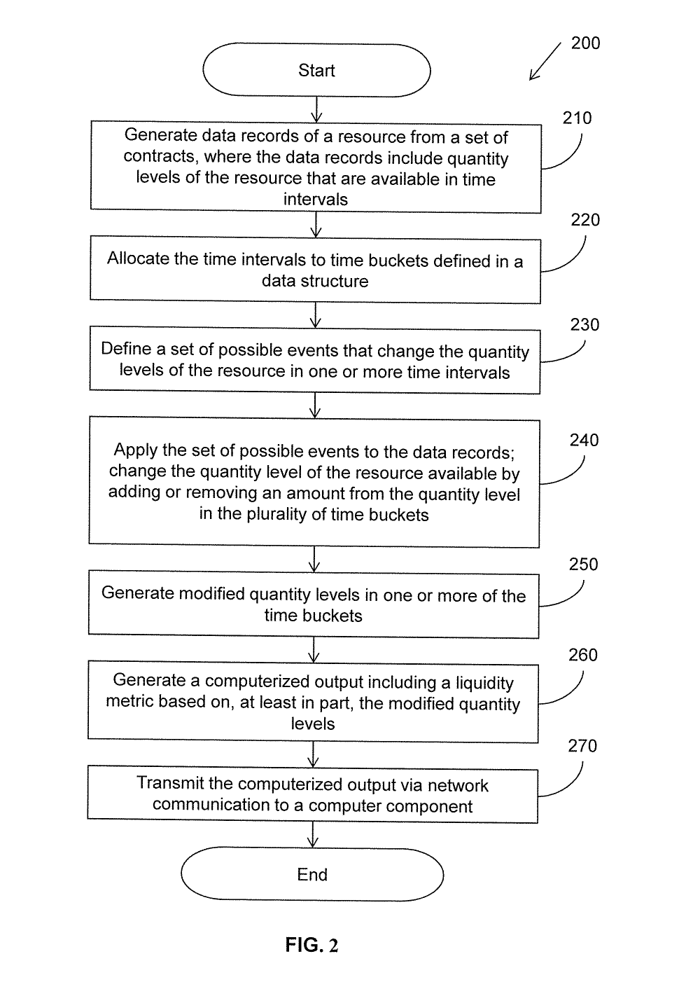

With continued reference to FIG. 1 and with reference to FIG. 2, the computing device 100 and the assumption engine 115 are described with a method 200 of operation. In one embodiment, the assumption engine 115 includes executable instructions that generate data records of a resource, using at least the processor 105 of the computer 100, from a set of contracts 140 that define usage terms for the resource (FIG. 2, block 210). The data records include quantity levels of the resource that are available in a plurality of time intervals. For example, the set of contracts 140 are stored in a database and the assumption engine 115 causes the processor 105 to read and retrieve data from the contracts 140, parse the data to identify terms of the contracts that include inflow and outflow conditions for the resource at various time intervals defined in each contract, and generate expected quantity levels of the resource at a variety of time intervals. For example, in a first day, X amount of the resource is expected to be used (outflow=decrease levels) and in a second day, Y amount of the resource is expected to be returned (inflow=increase levels). These quantity levels are determined and calculated for the existing contracts 140 and accumulated.

The assumption engine 115 further includes instructions that cause the processor to allocate the plurality of time intervals to a plurality of time buckets 125 defined in a data structure (FIG. 2, block 220). Each time bucket 1-N stores an associated quantity level of the resource that is expected in the time interval based on the terms from the set of contracts 140. For example, if the time buckets 125 are assigned for time intervals of a month, then expected quantity levels for the resource are determined and stored for each month of a time period (e.g., 12 months, or for each day of a month, etc.). Thus, based on the existing contracts 140, the time buckets 125 can be generated for a selected time period and determine an expected quantity level of the resource according to the terms of the contracts 140.

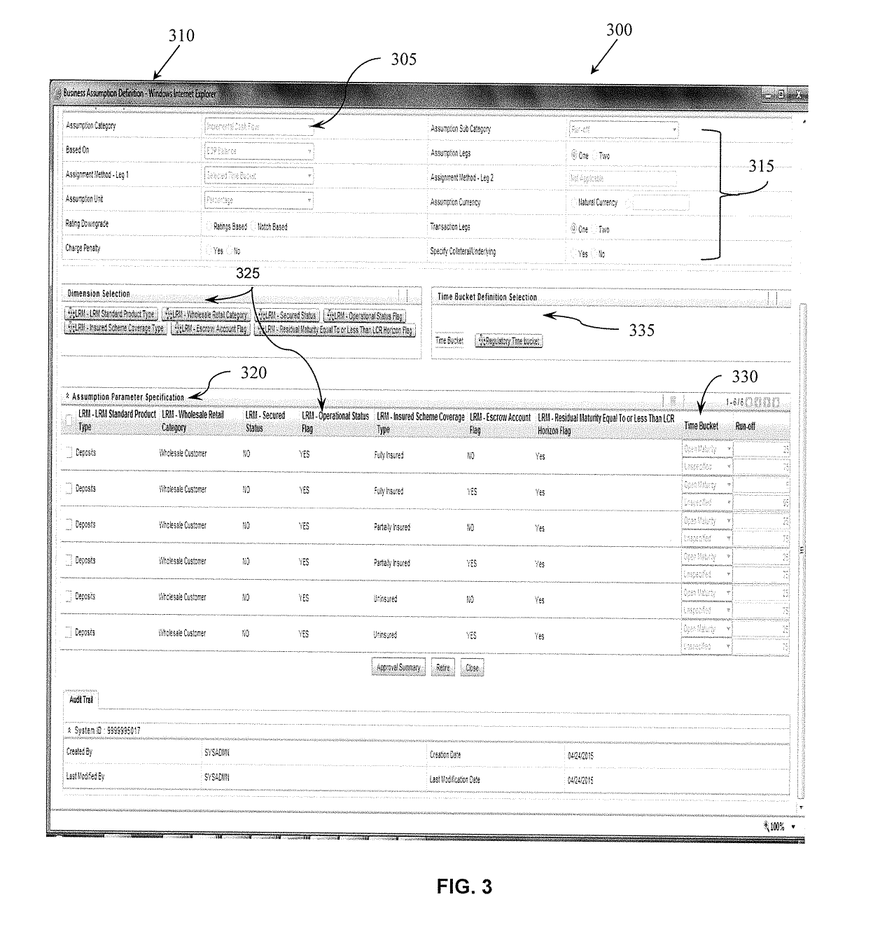

However, different events may occur in the future that change the expected quantity levels. Thus, the assumption engine 115 is configured to predict future quantity levels in view of one or more possible events occurring. The graphical user interface 120 includes instructions for defining a set of possible events that cause changes to the quantity levels of the resource in one or more of the time intervals (FIG. 2, block 230). Defining one or more events may include displaying fields on a display screen to receive input parameters of the event, receive parameters of the type of event and how the event affects the quantity level of the resource (rules for affecting cash level), and receive one or more time periods. Other examples are described in more detail with reference to FIG. 3.

With the defined assumptions/events 125 (and/or with one or more assumptions/events selected from the library of assumptions/events 130 via the GUI 120), the assumption engine 115 applies the assumptions/events to the quantity levels of the resource to predict future levels.

For example, the assumption engine 115 (FIG. 2, block 240) applies the set of possible events to the data records of the time buckets 125. The set of possible events change the quantity level of the resource available by adding or removing an amount from the quantity level in one or more of the time buckets 125. The assumption engine 115 generates modified quantity levels in the one or more of the time buckets based on the parameters of the events (FIG. 2, block 250).

After the assumptions/events are applied to the time bucket data structure 125 and the modified quantity levels are generated, the assumption engine 115 generates a computerized output 145 that represents the effects. In one embodiment, the computerized output 145 includes a liquidity metric based on, at least in part, the modified quantity levels as a result of applying the set of possible events (FIG. 2, block 260). The computerized output 145 represents an available quantity level of the resource during one or more of the plurality of time intervals based on a threshold level. In general, the threshold level is adjustable and set to a value that indicates whether the quantity level of the resource is below or above an acceptable level based on at least a requirement for the organization.

The assumption engine 115 may then cause the processor 115 to transmit the computerized output 145 via a network communication to a computer component (e.g., the display screen or a remote computer). The output 145 provides information to help control the levels of the resource by controlling the inflow and/or outflow of the resource at the time periods in question. For example, if more of the resource is required, computer signals can be generated to control orders to receive more quantities of the resource and/or to restrict quantities of the resource from being distributed out from the organization.

In the following embodiments, the resource that is monitored and processed by the assumption engine 115 is cash in an electronic form and the quantity level is cash flow in an electronic form. The embodiment will be described with reference to FIG. 1.

In one embodiment, the computing device 100 is configured with the assumption engine 115 that generates incremental cash flow (e.g., the resource) and controls cash flow movement based on the set of conditions/assumptions 125, 130 of possible occurring actions. In one embodiment, the assumption engine 115 is a computerized program product that includes modules of executable instructions (stored in a memory) for causing a computer to perform associated disclosed functions when the instructions are executed by the processor 105 of the computing device 100. It should be understood that all actions and functions described herein are implemented and performed by a computing device, and are not performed manually or mentally by a human. In one embodiment, the present system and method is implemented as part of a computer application for Liquidity Risk Management (LRM) for managing, controlling, and predicting liquidity metrics for an organization.

In one embodiment, cash flows of an organization are electronically defined in the system based on the existing contracts 140 with customers (called contractual cash flows). The organization may be a bank or financial institution. For example, the existing contracts 140 are stored in one or more databases. The computing device 100 accesses the databases via network communications, reads and parses data from the contracts 140, and determines properties of each contract that determine terms of the contract. The terms define, for example, amounts of cash involve and timing obligations for when an amount of cash is given to a customer (outflow) and/or when an amount of cash is required to be paid back by the customer (inflow).

Based on the contract terms from the existing contracts 140, the assumption engine 115 generates cash flow values for a selected point in time or for a time period (e.g., determine cash flow values at the end of each day of a month, at the end of each month of a year, etc.). The value of the contractual cash flows for any given time period is stored and allocated in the time bucket data structure 125. Time Bucketing is the process of allocating cash flows to defined time intervals (the time buckets 125). The assumption engine 115 can then analyze the allocated cash flows in the time buckets 125 to identify, measure, and manage liquidity risk of the organization by generating one or more liquidity metrics (output 145) from resulting cash flow values. The generated liquidity metrics are transmitted via computer communication as the output 145 to a display screen and/or as a network message to another computer. The output 145 is useful to help an analyst determine a cash flow state of the organization at various time periods and to cause electronic adjustments in cash flow levels to ensure that a threshold amount of cash is available at a given time period.

In one embodiment, the assumption engine 115 is configured to predict and generate a resulting state of the cash flow in response to a set of conditions/assumptions 125, 130 that may happen in the future (e.g., what-if scenarios). For example, the assumption engine 115, via the graphical user interface 120, allows a user to select one or more assumptions from the set of assumptions 130 that exist in storage (or allow the user to define a new assumption 125). An assumption is a condition or event that can change the state of the cash flow if the assumption occurs. Examples of assumptions include rollovers, run-offs, prepayments, delinquencies, haircuts, draw downs, asset sale, and so on, each of which can change an amount of cash associated with an existing contract in one or more time periods (time buckets). Each type of assumption (e.g., a rollover or prepayment) has a known effect on an account balance and thus affects the cash flow of the organization (e.g., increases or decreases cash flow at various time intervals). Each type of assumption is programmed with rules and parameters to computationally change an account balance or a set of accounts for affected time periods.

After one or more assumptions are selected and the assumption engine is initiated, the assumption engine 115 applies the one or more selected assumptions to the contractual cash flows as defined in the data structure of the time buckets 125. Thus the current state of cash flow (as allocated in the defined time buckets 125) is transformed in accordance to the effects of each assumption. As a result of the assumption occurring, the state of the cash flow is transformed to generate a post-assumption cash flow state where cash flow (i) is moved from one time bucket to another time bucket, (ii) is newly added to a time bucket, and/or (iii) is deleted from a time bucket, etc.

The change in cash flow is, for example, controlled by the effect on the cash flow that is caused by the type of assumption occurring. For example, if the assumption is a pre-payment of a loan, the existing expected cash flow of the loan as allocated in the time buckets is changed according to the pre-payment. The rules and parameters of the pre-payment assumption are executed by the processor to compute new cash flow values in the time buckets.

For example, the time bucket corresponding to the date of the loan payoff is increased with new cash flow (the pre-payment amount is inflow) while the time buckets of future expected interest payments from the loan are modified to delete the cash flow representing the loan interest and principal that is lost due to the prepayment. Thus, if a 12-month loan is paid back in full after the sixth month (a prepayment event), then the expected cash flow in the sixth month increases by the prepayment amount and the expected cash flow levels in months seven to twelve are decreased by the monthly payment since the payment in those months will no longer be received. A resulting data structure of cash flow is generated to represent and reflect the new cash flow state.

The resulting cash flow state is used to identify, measure, and manage liquidity risk of the organization in the event that the defined assumptions actually occurred. Using the resulting values of cash flow in the time buckets 125, the system 100 can determine and generate a report on a liquidity ratio, which is a ratio between the liquid assets and the liabilities of the organization.

With the present system 100 and method 200, the assumption engine 115 can be executed on a frequent basis (e.g., daily) with various possible scenarios of assumptions to generate a liquidity coverage ratio (LCR) and determine liquidity gaps across various time buckets. The present computerized system 100 improves the ability and efficiency to identify, measure, and manage liquidity risk of an organization by simplifying the input process for defining and applying assumptions, and reducing computation time for determining a resultant state of cash flow in time buckets.

Overview

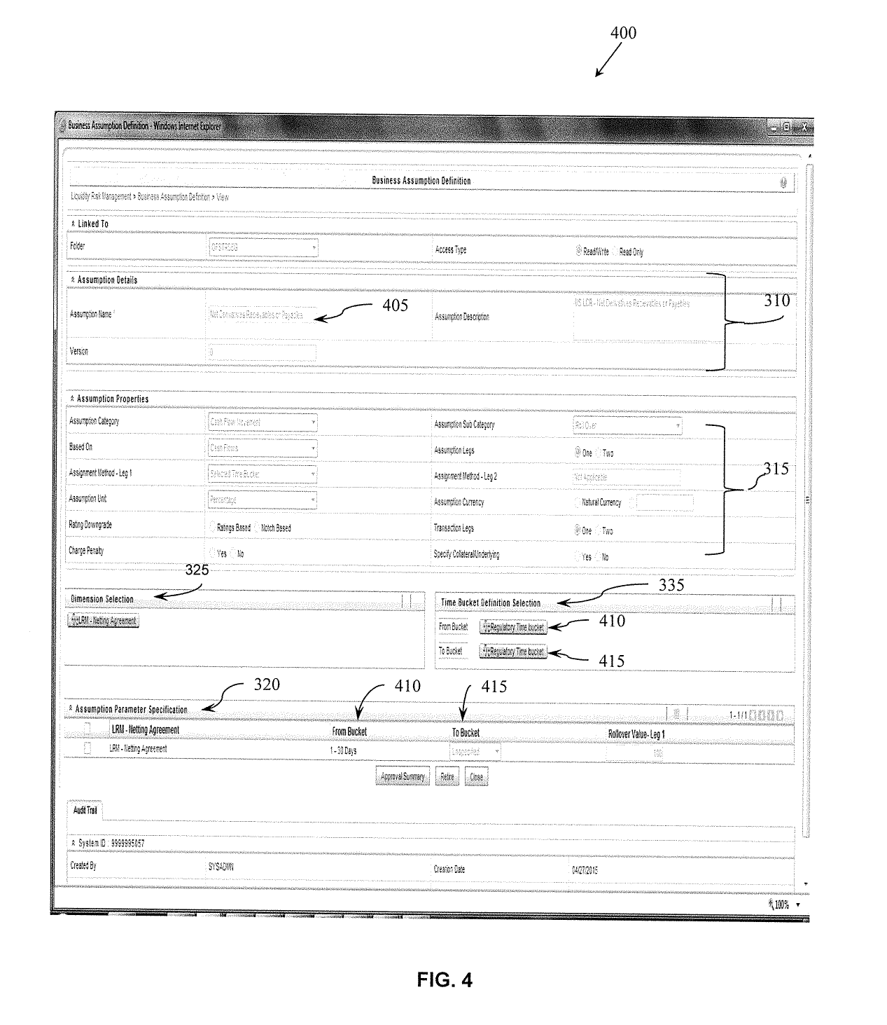

Assumptions (also called possible events) are behavior patterns exhibited by a bank's customers or by the bank itself which result in a change in the cash flows that occur under contractual terms. The assumptions/events are defined and stored as computerized objects with parameters. Example assumptions/events relating to cash flow include run-offs, prepayments, rollovers, draw downs, asset sale, delinquencies, recoveries, haircuts and so on. The assumption engine 115 allows assumptions to be electronically defined under normal conditions, that is, business-as-usual conditions, or under multiple stress conditions (e.g., unusual conditions), through the graphical user interface 120 configured to provide parametrized options (See FIGS. 3 and 4 for example screen images). Based on the defined assumptions, the assumption engine 115 generates and/or moves electronic values of cash flows between time buckets 125 according to a behavior associated with each assumption category applied.

In one embodiment, time buckets 125 are electronic data structures that define a time interval (e.g., hours 1-N, days 1-N, weeks 1-N, months 1-N, or years 1-N) into which a value of an amount of cash flow is allocated and stored as defined by the customer contracts 140. The contractual cash flows generated by a cash flow engine of a bank or any financial institution, forms the base for the assumption engine 115 which further applies cash flow behaviors like rollover of cash flows to a later cash flow date (later time bucket) or run-off of cash flows on prior cash flow date, thus impacting the various liquidity metrics. The engine 115 allows such scenarios to be defined which alters the cash flow pattern and thereby helps deduce various liquidity metrics if those scenarios occur.

The library of assumptions/events 130 includes a number of preprogrammed assumptions that define specific parameters about the assumption. Each type of assumption has a specific characteristic/behavior which could result in cash flow expected in one time bucket to be changed and flow in to another time bucket (e.g., prepayments, rollovers etc.) depending on various attributes of a customer or the bank. Or, an assumption could result in new cash flows flowing into a time bucket based on current balances of an associated customer (for example, assumptions such as run-offs, draw downs, asset sale etc.). For example, an assumption category like an asset sale has a known behavior/effect on cash flow, which is preprogrammed into the system. Thus, when an asset sale is selected as an assumption, the system executes and applies asset sale calculations (using also input parameters of the sale) to the appropriate cash flow in time buckets 125 to generate new values of the cash flow.

Description of a Few Examples of Assumption Category Behaviors:

1. Cash Flow Movement—Roll Over: Rollover refers to the rescheduling of a certain percentage of cash flows to a future time bucket/band. This occurs when an asset or liability is renewed for an additional term. The amount of cash flow rolled over is thus reduced or increased from the original time bucket and assigned to the new time bucket in the future.

2. Cash Flow Movement—Asset Sale: This assumption is a specific case of cash flow movement category where cash flows posted in an original maturity time band (time band will also be referred to as time bucket) of an asset are moved to a prior time bucket due to a sale. This assumption allows a user to specify a sale of unencumbered marketable, fixed or other assets to advance the cash inflows. Sale can be specified on each individual asset or as a combination of dimensions. This assumption allows a user to specify a partial sale of assets by specifying/inputting a sale amount. The result is that the assumption reverses all original cash flows that occur between the sale time bucket and maturity time bucket and posts the market value less a haircut in the sale time bucket.

3. Cash Flow Movement—Prepayment: Prepayment is a situation where a customer repays a loan in part or full, at any time before the maturity of the loan. Prepayment would lead the bank to lose out on the interest component that would have been received if the loan was not pre-paid. Prepayment results in a cash inflow in a time bucket prior to the original time bucket and reduces cash inflow in the original time buckets (e.g., the next X months of time buckets lose the expected cash flow from the original expected interest from the loan).

4. Incremental Cash Flow—Run-Off: Incremental Cash Flow Run-off is applied to the End of Period (EOP) balances indicating an amount that is withdrawn prior to their scheduled maturity. The computation methodology has one additional step, that is, if cash flows exist for a dimension combination for which run-off is specified, the cash flows are deleted and then new cash outflows are generated and allocated to the appropriate time bucket(s).

5. Incremental Cash Flow—Drawdown: Drawdown of Unutilized Credit: Banks generally allow customers to withdraw a certain amount of cash, which is a percentage of a value specified as a limit. This business assumption is applied to the undrawn portion of cash, the assumption being that certain portions of the undrawn amount is drawn by the customer at the specified time bucket thus leading to additional cash outflows. This assumption also allows a user to specify the corresponding cash inflow for the specified cash outflow.

Drawdown of Funding Line of Credit: Banks receive lines of credit from other banks and financial institutions. The bank can drawdown these lines as per a requirement at any time during the tenure of the facility. A percentage of the total undrawn amount is assumed to be drawn down over each time bucket. Drawdown of funding line of credit results in cash inflow first and outflow at a later date. This assumption also allows the user to specify the corresponding cash outflow for the specified cash inflow.

Of course, other types of transactions can be implemented and programmed into the system according to their behavior/effect on cash flow.

The following section describes various examples of cash flow assignment methodologies that are implemented in one embodiment of the assumption engine 115:

1. Selected Time Bucket

In this case, an assumption unit is applied to the cash flows and the assumption cash flows are mapped to the time bucket 125 selected. If the assumption is not specified on Level 0 buckets, then the assignment to the lower buckets is done proportionately to the bucket size. Example Level 0 time buckets are Overnight, 1-7 Days, 8-15 Days, 16-30 Days, 1-3 Months, 3-6 Months, 6-12 Months, 1-5 years and >5 Years.

2. Equal Assignment

Here cash flows assigned to each time bucket 125 are up to a selected time bucket. Assignments are made equally to the selected level and further assignment is done until a selected granular level.

3. Increasing Assignment

Cash flows are assigned to each time bucket up to the selected bucket in increasing order based on ranks assigned to cash flows. Assignments are made in increasing order to the selected level and further assignment is done until a selected granular level.

In general, the cash flow treatment method is different for each assumption. Each assumption is programmed with a different set of computations (rules) and appropriate allocation of cash flow as defined by the resulting transaction of the assumption. The conventional way to compute these metrics would be to invoke a cashflow engine (CFE) that generates the cashflows for specific time buckets looking at a yield curve. However, this time consuming process does not generate liquidity metrics one a daily basis and also did not monitor other liquidity parameters all through the day. The present system 100 greatly improves the process of determining liquidity metrics.

The assumption engine 115 provides an improvement to the computing system 100 since the engine 115 is configured to perform the computation and allocation/assignment of the cash flows as per the assumption characteristics. Along with the rules defined for each assumption, each assumption tasks are grouped as a program module called process which performs the tasks pertaining to an assumption. Further, many such processes (assumptions) can be selectively grouped to run on the contractual cash flow data structure to analyze the outcome of various assumptions. On execution, one or multiple assumptions are applied to the contractual cash flows whose attributes correspond to the dimensions specified in the assumption. The application of an assumption results in an increase or decrease in cash flows in certain time buckets, movement of cash flows from one time bucket to another, change in the value or the encumbrance status of an account depending on the type of business assumption. In one embodiment, the output result 145 includes a liquidity metric and the modified electronic values of cash flows in the data structure of the time buckets 125, which are used to identify, measure, and control liquidity risk of the organization in response to applying the assumptions.

The assumptions 125, 130 can be defined (via the GUI 120) with varying parameters to simulate multiple conditions that differ in magnitude of the behavior exhibited, which results in either change in the cash inflows and outflows. For example, a run-off rate under normal conditions for certain deposits may be 2%. Under a mild stress scenario, the run-off rate may be 8% and under a severe and prolonged stress scenario, rate may be 20%. The GUI 120 provides input fields to adjust the parameter for the run-off rate. The assumption engine 115 allows users to define and maintain the library of assumptions 130 of varying magnitudes and with different parameters. Once saved in storage, an assumption may be registered as a Process in a Rules Framework and can be used across multiple scenarios, Runs and time periods for computing liquidity risk metrics.

The assumptions can also be used to compute liquidity gaps and liquidity ratios under business as usual (BAU) scenarios and under stress scenarios.

The graphical user interface 120 of the assumption engine 115 provides an input mechanism for defining assumptions for different scenarios. FIG. 3 illustrates an example screen of the graphical user interface 120, which is discussed below. The GUI 120 gives options for selecting a variety of input parameters such as a behavior, a type of reference measure, an input percentage/value variance to apply for the assumption to move/generate the cash flow, attributes of an account which determines if the assumption is applicable or not to the account, a time bucket on which the particular assumption should be working, assignment methods, etc.

The user interface (for selecting input parameters) coupled with the assumption engine 115 provides functions to a user to generate liquidity coverage ratio and liquidity gaps across various time buckets 125, which may be executed at the end of every business day in a time effective manner.

With the present assumption engine 115, the engine is configured to simulate actual (business as usual) scenarios and compare those scenarios against the contractual behavior of the contractual cash flow and analyze the effect of each assumption on liquidity gaps and liquidity ratios as a result of executing the assumptions on the contractual cash flow.

Without having to invoke a cash flow engine, but effectively applying the cash flow behavior patterns, the assumption engine 115 is benchmarked in a half rack Exadata machine to run and execute cash flow transformations applying a variety of defined business assumptions to cash flow records as explained herein. The system completed execution within 2 hours and 45 minutes for 40 million customer accounts and 2 billion cash flow records. Thus the present system provides efficient processing of data records and more accurate predictions of liquidity metrics. It should also be apparent that the present system cannot be performed manually by a human due to the volume of data records, limited time frames, complexity, and manipulation of data structures.

### Example

### Incremental Cash Flow (FIG. 3)

With reference to FIG. 3 (and FIG. 1), one embodiment a screen image 300 of the graphical user interface (GUI) 120 is illustrated, which is configured to provide input options and selections for defining one or more assumptions/events 125. The input options include identifying an “assumption category” in field 305, which in the FIG. 3 states “incremental cash flow”, and parameters associated with the assumption, which are input via the GUI 120 of the system of FIG. 1.

The assumption engine 115 (FIG. 1) is configured to generate the GUI screen 300 and display the screen 300 on a display screen of the computing device 100. In one embodiment, GUI screen 300 has 3 sections: 1. Assumption Details 310 (see also FIG. 4); 2. Assumption properties 315; and 3. Assumption parameter specification 320.

1. Assumption Details 310 identifies a name and description of the assumption. In FIG. 1, the Assumption Category field 305 indicates “Incremental Cash Flow.” The Assumption Sub Category field indicates “Run-off.”

2. Assumption properties 315: This section is configured with options for selecting the assumption attributes e.g., category, sub category, based on measure, assignment method, assignment unit, etc. And, the dimensions on which the assumption works (the “Dimension Selection” section). These assumption attributes defines the properties of the cash flow.

3. Assumption parameter specification 320: This section provides details about the assumption applied on the contract data 140. For example, the parameters 320 function as a filter to identify/match customer records that the assumption will be applied to. This section shows a column in the table for each dimension selected in the “Dimension Selection” section, which function as filter criteria for determining which customer records will be used during execution of the defined assumption.

After the assumption parameters are specified in the GUI 300, the assumption engine 115 executes and applies the parameters to the cash flow data records 125 of the matching customer records to generate resulting cash flow data records/data structure as described previously.

With reference to the “Assumption Parameter specification section” 320 in FIG. 3, consider a first combination of parameters as shown in the input fields (which correspond to the list of parameters in the “Dimension Selection”):

LRM (Liquidity Risk Management)—LRM Standard Product Type=Deposits

LRM—Wholesale Retail Category=Wholesale Customer LRM—Secured Status=NO

LRM—Operational Status Flag=YES

LRM—Insured Scheme Coverage Type=Fully Insured LRM—Escrow Account Flag=NO

LRM—Residual Maturity Equal To or Less Than LCR Horizon Flag=Yes

This assumption means, for all the “wholesale customers” with product as “deposit” whose “secured status=No”, operational status=‘Yes’, which is Fully Insured, not an Escrow account and maturing within the Liquidity Coverage Ratio (LCR) horizon (the time horizon considered for LCR computation) then introduce/apply a cash flow of 25% EOP (End Of Period) Balance in ‘Open Maturity’ time bucket and 75% of EOP Balance in ‘Unspecified’ time bucket. Thus, customer records that match the specified parameters are matched and identified from a customer record database and the assumption is applied to their cash flow records as specified.

With above given assumption condition, the engine generates cash flows which will be 25% of EOP balance of all the accounts satisfying the above condition and will be posted to ‘Open Maturity’ time bucket and 75% of the cash flows will be posted to “Unspecified” time bucket.

A similar approach is followed in case of cash movement assumptions as well. But, the process adjusts the contractual cash flows to a new time bucket, unlike generating new cash flows in case of incremental cash flow assumptions.

With continued reference to FIG. 3 and the GUI screen 300, a variety of input parameters are programmed in the graphical user interface 120 for defining an assumption and parameters that represent the assumption and how the assumption functions.

A few parameters/options used for defining a business assumption are as follows as shown in assumption details 310 section on screen 300: Assumption Category, Assumption Sub-Category, Based On, Assumption Legs, Assignment Method—Leg 1, Assignment Method—Leg 2, Assumption Unit, Assumption Currency, Ratings Downgrade, Transaction Legs, Charge Penalty.

Business Assumption Definition 310 parameters:

There are multiple parameters for a business assumption definition, which create multiple conditions differing in magnitude of the behavior exhibited by the assumption when applied to an account. Applying the assumption ultimately results in either change in the cash inflows and cash outflows.

The GUI screen 300 is implemented with the following types of assumptions categories and sub categories, which are provided as selectable options (e.g., drop down list) from the input field:

Assumption categories: (a) Cash Flow Movement, (b) Encumbrance, (c) Incremental Cash Flow, (d) Value Change.

Assumption sub categories for each type of assumption categories may be as follows:

a) Cash Flow Movement sub-categories: Cash Flow Movement, Asset Sale, Cash Flow Delay, Delinquency, Prepayment, Recovery, Rollover, Run-off

b) Encumbrance sub-categories: Encumbrance, Ratings Downgrade, Valuation Changes

c) Incremental Cash Flow sub-categories: Incremental Cash Flow, Drawdown, New Business, Ratings Downgrade, Run-off, Secured Funding/Financing, Valuation Changes.

d) Value Change sub-categories: Available Stable Funding Factor, Haircut, and Required Stable Funding Factor.

Regarding the “Based On” option in the assumption definition section 310, the option determines a measure that the assumption values are applied to in order to obtain cash flows. From a drop-down list programmed in the input field, a user is permitted to select the option on which different assumption values are applied.

Regarding the “Assumption Legs” option, this option determines if only the off-set leg or both the primary and the off-set legs are selected for the purpose of specifying the business assumption value as part of the assumption specification section 320. Thus the selectable input options are “One” or “Two” as shown next to the “Assumption Legs” field. The assumption legs are based on the type of business assumption being specified. For instance, in case of rollover, prepayments, Run-offs etc. assumption values are applied to the off-set leg as the primary leg of the transaction has already occurred in the past. However, in case of a new business assumption, such as deposit growth, both the primary leg (amount deposited) and the off-set leg (repayment of amount deposited) are required as both legs occur in the future. The selection is determined by the assumption sub category selected. In case of sub categories where only one option is applicable, the selection will be defaulted in an un-editable mode. In cases where both values are applicable, the following options are available selections:

“One”: In case One is selected as the assumption leg, then one column appears for entering the off-set assumption value.

“Two”: In case Two is selected as the assumption leg, then two columns appear for entering primary assumption value and secondary or off-set value.

Regarding the “Assignment Method” option, this option determines how the primary assumption value is allocated to the time buckets 125. There are specific methods in which the assumption value can be distributed across the time buckets. Assignment methods determine the manner in which the primary assumption values are assigned to multiple buckets in order to determine the cash flows.

The options for the Assignment Method are as follows: Selected Time Bucket, Increasing, Decreasing, Equal, Proportionate

The Assignment Method “Leg 1” option is applicable when one leg of a transaction is affected i.e. when the “assumption legs” field value is selected as “One”.

The “Assumption Unit” option is an option that helps to identify a unit based on which the assumption is defined. The options which can be selected from a drop-down list are as follows: Amount, Percentage, and Units. “Units” are only applicable on selection of the sub category “Asset Sale” as part of the Cash Flow Movement assumption category.

The “Assumption Currency” option is an option applicable only when the assumption unit is selected as “Amount.” When the assumption unit is selected as “Amount”, then following options are displayed: Natural Currency, or a Currency Selection is available for input.

The “Ratings Downgrade” option caters to a downgrade of a legal entity's rating. The option identifies a downgrade level for the purpose of triggering a request for additional collateral for the entity. The parameter identifies the downgrade specified for a legal entity as: Rating Based or, Notches Based.

The “Transaction Legs” option is an option that determines if one or two off-set legs are required for the purpose of specifying the business assumption value as part of the assumption specification section. The selectable options are “One” or “Two” as shown in the screen 300. The option is based on a product type. For instance, in case of loans, deposits etc., there is only one primary leg and one off-set leg whereas in the case of swaps, there are two primary and two off-set legs for the same transaction.

One of the following options is selectable: (1) “One”: In case option One is selected, only one column for the specification of each assumption leg is displayed as part of the assumption specification table that is, one column each for primary and off-set assumption value specification, or (2) “Two”: In case option Two is selected, two columns are displayed for specifying each assumption leg that is two columns each for primary and off-set assumption value specification.

The “Charge Penalty” option includes “Yes” and “No” selectable buttons. In case “Yes” is selected, an additional column in the assumption value grid is added to specify penalty. If “No” is selected, no penalty is required.

The “Specify Collateral//Underlying” option includes “Yes” and “No” selectable buttons. The option determines if existing unencumbered assets are required to be posted as collateral or underlying in the case of secured funding and repo transactions. If “Yes” is selected, existing assets can be posted as collateral for each row in the assumption specification table. If “No” is selected, no collateral is required.

With continued reference to FIG. 3 and the GUI screen 300, the Assumption Parameter Specification 320 table is now discussed.

An assumption specification table is generated after the assumption properties, dimensions and time buckets are selected from the previous sections on the GUI screen 300. The specification table 320 displays the dimensions selected 325 as column values in the specification table 320 and the dimension members as row values on the GUI screen 300. Additionally, the specification section 320 displays one or two time bucket columns 330 based on the assumption properties selected previously.

Selecting Dimensions 325 includes, for example, two steps as follows:

(1) Dimension Selection: One or multiple dimensions can be selected from a list of dimensions displayed in a dimension browser that can be displayed. The selected dimensions are displayed in the dimension selection section 325 and as columns in the assumption specification table 320. You are allowed to drag and drop the dimensions which are displayed as part of the dimension selection section for sequencing the dimensions. In case the sequence of dimensions is changed, the respective columns in the assumption specification table get re-arranged.

In case new dimensions are added to an existing definition, the assumption specification table 320 is re-formed and all assumption values are reset.

(2) Dimension Member Selection: One or multiple members can be selected for each selected dimension. The selected dimension members are displayed as row items in the assumption specification table 320. In case any dimension member is changed or a new dimension is added to the existing definition, the table 320 rows and columns are reset.

Time Bucket Definition Selection 335

One time bucket definition can be selected from a list of definitions displayed in a time bucket definition browser 335. On selection of a time bucket definition, the selection is displayed in the time bucket definition selection 335 against columns <Time Bucket 1> Selection 330 and <Time Bucket 2> Selection (not shown).

The <Time Bucket 1> Selection: One or multiple time buckets from a given time bucket definition can be selected as part of <Time Bucket 1> Selection. The selected time buckets are displayed as row items 330 in the assumption specification table 320. The name of the time bucket parameter changes depending upon on the assumption category selected as per a mapping provided in Table 1 below:

TABLE 1

| Assumption Category | <Time Bucket 1> Selection |
|---|---|
| Cash Flow Movement | From Bucket Selection |
| Incremental Cash Flows | Primary Bucket Selection |
| Encumbrance | From Bucket Selection |
| Value Change | Not Applicable |

The <Time Bucket 2> Selection: One or multiple time buckets defined as part of the selected time bucket definition 335 can be selected as part of <Time Bucket 2> Selection. The time buckets selected are displayed as drop-down values in a <Time Bucket 2> column (next to time bucket column 330) in each row of the assumption specification table. The name of the parameter changes depending upon the assumption category selected as per a mapping provided in Table 2 below:

TABLE 2

| Assumption Category | <Time Bucket 2> Selection |
|---|---|
| Cash Flow Movement | To Bucket Selection |
| Incremental Cash Flows | Off-set Bucket Selection |
| Encumbrance | To Bucket Selection |
| Value Change | Not Applicable |

In the assumption parameter specification 320 (see FIG. 4), names of the columns <Time Bucket1>(“From Bucket” 410) and <Time Bucket2>(“To Bucket” 415) are displayed based on assumption category as in Table 3:

TABLE 3

| Assumption Category | <Time Bucket 1> | <Time Bucket 2> |
|---|---|---|
| Cash Flow Movement | From Bucket | To Bucket |
| Incremental Cash Flows | Primary Bucket | Off-set Bucket |
| Encumbrance | From Bucket | To Bucket |
| Asset Value Change | Not Applicable | Not Applicable |

### Example

### Cash Flow Movement (FIG. 4)

With reference to FIG. 4, one embodiment of a screen image 400 of the graphical user interface (GUI) 120 is illustrated for defining an assumption/event for an assumption category of “cash flow movement” and parameters associated with the assumption, which are input to the GUI 120. In FIG. 4, the “Assumption Name” field 405 indicates “Net Derivatives Receivables or Payables.” Thus this assumption has a Dimension Selection as LRM—Netting Agreement=LRM—Netting Agreement.

This assumption means, for all the “Netting Agreement” products, move 100% cash flows occurring in “1-30 days” time bucket (the “From Bucket” field 410) to “Unspecified” (the “To Bucket” field 415) (equivalent of “other category” time bucket, cash flows in such time bucket are not considered for further computation in LRM application.). While doing this 100% cash flows are adjusted in “1-30 days” time bucket (reduce by 100% in this example) and post the 100% cash flows of “Netting Agreement” in “Unspecified” time bucket (as seen in the assumption parameter specification section 320).

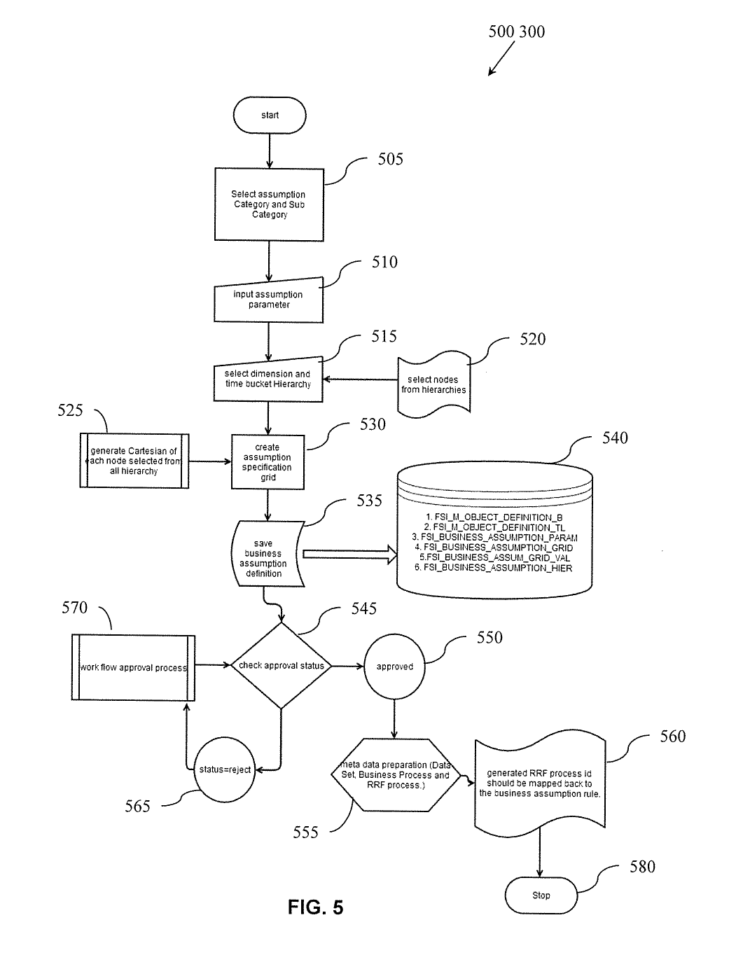

FIG. 5—Generating Metadata Embodiment

In one embodiment, the above mentioned attributes of the assumption are stored as metadata in a data structure in the computing device 100. An assumption definition flow diagram 500, with reference to FIG. 5, describes an example method of the data flow and algorithm in generating the metadata for the assumptions by the assumption engine 115 using the input data from the graphical user interface 120.

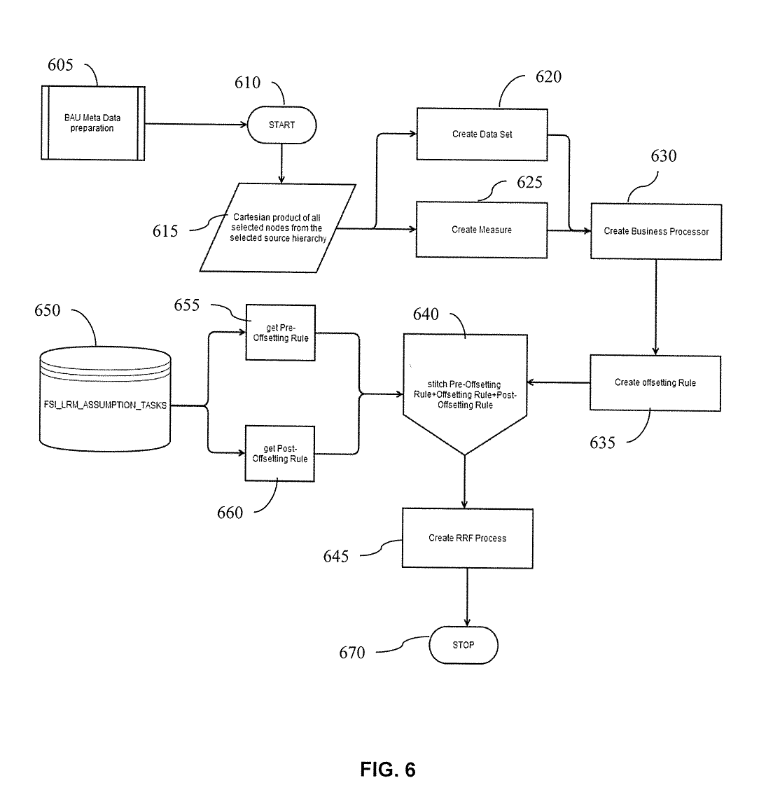

The metadata created in the method 500 is further used by a set of functions/procedures/packages collectively called Data Transformations (DT, which are program components/modules of the computer application that are stored in a non-transitory computer storage medium and executable by the processor 105. The program modules, when executed, interact with each other to either move the cash flows or generate new cash flows in the time bucket data structure 125. The data flow diagram of transformation of metadata to assumption cash flows generated by assumption engine 115 is shown in FIG. 6 and describes a method of data flow of transformation of the assumption metadata into cash flow output.

In one embodiment, as previously explained, the system 100 (FIG. 1) includes the library of assumptions/events 130, which are programmed with corresponding rules. The rules identify and control how the assumption affects cash flow based on the transaction. Thus an assumption of an asset sale is a known type of transaction that has a known effect on cash flow once the parameters of the asset sale are inputted (e.g., identify customer and asset, sale amount, sale date, and so on). The rule programmed for the assumption causes the effected customer record and the corresponding cash flow records to be modified according to the transaction parameters, which results in output cash flow records/data structure with new cash values.

Such rules are defined, generated, and stored for each type of assumption. When executed by the processor 105, the rules are run by a run rules framework (RFF), which in one embodiment is a software-implemented rules engine that functions by applying a set of rules to objects in working memory.

Regarding the “assumption parameter specification” 320 (FIG. 3), each assumption has different applicable parameters just as they have different rules. Parameters are different for different sub-categories as well. For example, a “run-off” has specific parameters that apply to a run-off transaction, which do not apply to other types of transactions. In one embodiment, in response to the assumption “category” and “sub-category” being specified, the system enables only the parameters that apply to the selected sub-category and disables all other possible parameters. The enabled parameters are shown in the “Dimension Selection” section as selectable icons (see FIG. 3 that shows parameters for assumption sub-category “run-off”).

With reference to FIG. 5, after the graphical user interface 120 is initiated, the input screen 300 (FIG. 3) is generated and displayed. The method 500 is described with reference to the input fields as shown in the input screen 300 of FIG. 3.

Block 505: Select Assumption Category and Sub Category

As part of the assumption definition, the GUI 300 provides input fields to select an assumption/event category and sub category from a list of available categories. The available categories correspond to the types of assumptions that exist in the library of assumptions 130 that have been programmed with rules and parameters that affect cash flow.

The assumption/event category and sub category parameters define the resulting cash flow generation whether (i) the categories are based on a position/instrument/account data or on contractual cash flows data, or (ii) whether the category parameters are used to generate afresh in a target time bucket or a movement of contractual cash flows from a source time bucket to a target time bucket in the time bucket data structure 125.

A list of assumption categories and sub categories may be listed in the input fields 310 of the GUI screen 300 as a drop down list.

Block 510: Input Assumption Parameter

At block 510, assumption parameters are provided by the GUI screen 300 as additional parameters to be received as input, which further dictate the cash flow generation/movement. For example, parameter “Based on” determines an account/cash flow measure on which resulting cash flows are generated. An “Assumption legs” option determines if the cash flows are to be generated for off-set leg or both the primary and the off-set legs (options for selection “One” or “Two”).

Some of the input assumption parameters may be optional based on the assumption category and sub category. Different types of categories may have different types of assumption parameters. The following is a list of input assumption parameters that can be specified via the GUI 120:

Based On; Assumption Legs; Assignment Method—Leg 1; Assignment Method—Leg 2; Assumption Unit; Assumption Currency; Ratings Downgrade; Transaction Legs; Charge Penalty

A brief description of the above parameters is provided as part of discussion of FIG. 3.

Block 515: Select Dimension and Time Bucket Hierarchy

The assumption engine 115 generates cash flows based on dimensional attributes like product type, counterparty type, and brokered deposit type etc., of an instrument/position or contractual cash flow and in the specified time bucket 125. Hierarchies are created on each of the dimensional attributes including the time bucket that is received as input. The corresponding hierarchies of the dimensions received as an input via the input screen 300 after being selected by a user.

Block 520: Select Nodes from Hierarchies

At block 520, individual values from each of the dimension (hierarchical nodes) are received as input by the GUI screen 300 in response to being selected by the user as part of the assumption definition.

Block 525 and 530: Generate Cartesian of Nodes Selected from all Hierarchies

After the individual nodes from each hierarchy are selected, the nodes of a hierarchy are displayed in a single column and a row and includes a node from every hierarchy. A Cartesian product of the hierarchies (the nodes) is formed on the assumption parameter specification grid. The GUI screen 300 provides input fields for receiving input from the user who enters the assumption values for applicable combinations.

The source time bucket (primary time bucket) is part of Cartesian grid whereas the target time bucket (off-set time bucket) is a drop down selection.

Block 535 and 540: Save Assumption Definition

At block 535, the assumption definition data is stored in database tables when the assumption is saved. The assumption definition data is stored in database tables of different granularities (block 540). For example, FSI_M_OBJECT_DEFINITION_B: Stores the assumption object definition id which is used to uniquely identify the assumption throughout the application.

FSI_M_OBJECT_DEFINITION_TL: Stores the assumption description with multi language support.

FSI_BUSINESS_ASSUMPTION_PARAM: Stores the assumption parameters that dictate the course of the assumption (parameters explained in Block 510: Input assumption parameter).

FSI_BUSINESS_ASSUMPTION_GRID: Stores a Cartesian product of hierarchy nodes (assumption grid) in order which are rendered back when the user opens the assumption definition.

FSI_BUSINESS_ASSUM_GRID_VAL: Stores the assumption value provided against the applicable rows in the assumption grid.

FSI_BUSINESS_ASSUMPTION_HIER: Stores the unique hierarchy nodes which are selected as part of dimension selection. It stores the node identifier and hierarchy dimension table, its primary key details.

Block 545, 565, 570, 550: Workflow Approval Process

At block 545, an approval status is checked for approving workflows based on user roles. Assumptions which are defined within the GUI 120 and screen 300 are reviewed for approved before the assumptions can be used for computations. When a new assumption is defined, the assumption is assigned a “draft” status. When a user finalizes on the assumption definition, the assumption definition is sent for approval. A user with a proper authority, as determined from the user's role or profile information, can approve or reject the assumption. If rejected (block 565), the assumption definition remains in draft state and the system allows the user to edit the assumption definition and then resend for approval (block 570).

At block 550, once the assumption definition is approved, metadata to process the assumption definition is generated.

Block 555 and 560: Metadata Preparation and Mapping Run Rule Framework (RRF) Process Id to Assumption

At block 555, after being approved, the assumption definition is registered as a Process stored in the library of assumptions 130 (and/or in a Run Rules Framework of an application infrastructure) and is made available to be used across multiple scenarios, runs and time periods for computing liquidity risk metrics.

The stored process in turn includes the rule, data transformation and the rule is built of metadata objects like measure, hierarchy and business processor. At block 560, a process id generated as part of the assumption approval is mapped to this object definition in a database mapping table. The method 500 ends at block 580.

FIG. 6—Transformation of Metadata to Assumption Cash Flows

With reference to FIG. 6, one embodiment of a data flow diagram of transformation of the metadata (that was generated during the process of FIG. 5) to assumption cash flows generated by the assumption engine 115 is illustrated. FIG. 6 also illustrates an overview of a data flow of transformation of the assumption metadata into cash flow output by the assumption engine 115. Metadata generated in FIG. 5 (and from the user interface input) is further used by a set of functions/procedures/packages collectively called as Data Transformations (DT, which are implemented as program modules of the computer system 100), which interact with each other to either move the cash flows from one time bucket to another time bucket, or generate new cash flows and allocate/store the new cash flows in a time bucket.

Blocks 605, 610, 615:

At block 605, a business as usual (BAU) metadata preparation process is requested and initiated (block 610). In case of assumption category cash flow movement, reducing contractual cash flows from a primary time bucket is done through a run rules framework RRF computational rule. Basic metadata elements used to define this rule are in block 615 including:

Hierarchy Nodes: Hierarchy nodes are selected in the assumption and appear in the rule combination mapper as in the assumption screen 300 (Cartesian product of hierarchy nodes). Each individual hierarchy node denotes a dimensional value.

For Example: Hierarchy node may represent DIM_PRODUCT.V_PROD_CODE=‘LOAN’

Block 620:

Dataset is created: The dataset defines a join condition between a fact table (cash flow table) and a dimensions tables on which the hierarchies for the assumption are defined.

For Example:

```
FCT_AGG_CASH_FLOWS
  INNER JOIN DIM_STANDARD_PRODUCT_TYPE ON
DIM_STANDARD_PRODUCT_TYPE.n_standard_product_type_skey =
FCT_AGG_CASH_FLOWS.N_STANDARD_PRODUCT_TYPE_SKEY
  INNER JOIN DIM_STANDARD_PARTY_TYPE ON
DIM_STANDARD_PARTY_TYPE.n_standard_party_type_skey =
FCT_AGG_CASH_FLOWS.N_STANDARD_CUSTOMER_TYPE_SKEY
INNER JOIN DIM_RUN ON FCT_AGG_CASH_FLOWS.N_RUN_SKEY =
```

DIM_RUN.N_RUN_SKEY

INNER JOIN DIM_DATES ON FCT_AGG_CASH_FLOWS.N_AS_OF_DATE_SKEY =

DIM_DATES.N_DATE_SKEY

INNER JOIN DIM_PRODUCT ON FCT_AGG_CASH_FLOWS.N_PROD_SKEY =
DIM_PRODUCT.N_PROD_SKEY
INNER JOIN DIM_RESULT_BUCKET ON
FCT_AGG_CASH_FLOWS.N_RESULT_BUCKET_SKEY =

DIM_RESULT_BUCKET.N_RESULT_BUCKET_SKEY

Block 625:

At block 625, the assumption engine 115 creates a measure. A measure is a uniquely named data element. In the case of an assumption, measures are created on target column and source columns of the resulting cash flow computation. For Example: Measure is defined for the below column:

FCT_AGG_CASH_FLOWS.N_INFLOW_AMT_RCY

Block 630:

At block 635, the assumption engine 115 creates a business processor, which defines a computational expression of the offsetting cash flow calculation. A target column (Target measure) is specified via the GUI screen 300 to which the computational expression is applied. For example:

CASE WHEN dim_product.v_balance_sheet_category

IN (‘ASSET’, ‘OFF BALANCE SHEET’)

THEN

FCT_AGG_CASH_FLOWS.N_INFLOW_AMT_RCY −

(FCT_AGG_CASH_FLOWS.N_INFLOW_AMT_RCY *
([Assum_Pct]/100))
ELSE

fct_agg_cash_flows.n_adj_inflow_amt_rcy

END

Block 635:

At block 635, the assumption engine 115 processes the individual constructs (Dataset, Measures and Business processors) and organizes them together in a rule. The rule when executed translates into an update implemented in SQL MERGE syntax which does the offsetting in the cash flow table. Example program algorithm is seen in Table 4:

TABLE 4
MERGE INTO FCT_AGG_CASH_FLOWS TRGT
USING (SELECT PK_COLS,
CASE
WHEN DIM_PRODUCT.V_PROD_CODE =
‘LOAN’ AND DIM_ORG_STRUCTURE.V_ENTITY_CODE =
‘LE01’ AND
DIM_RESULT_BUCKET.V_BUCKET_NUMBER_CATEGORY =
‘TB1’ THEN
1
WHEN DIM_PRODUCT.V_PROD_CODE =
‘CARD’ AND DIM_ORG_STRUCTURE.V_ENTITY_CODE =
‘LE01’ AND
DIM_RESULT_BUCKET.V_BUCKET_NUMBER_CATEGORY =
‘TB2’ THEN
2
WHEN DIM_PRODUCT.V_PROD_CODE =
‘DEPOSIT’ AND DIM_ORG_STRUCTURE.V_ENTITY_CODE =
‘LE02’ AND
DIM_RESULT_BUCKET.V_BUCKET_NUMBER_CATEGORY =
‘TB1’ THEN
3
ELSE
4
END HIER_CODE,
CASE WHEN DIM_PRODUCT.V_BALANCE_SHEET_CATEGORY
IN (‘ASSET’, ‘OFF BALANCE SHEET’)
THEN
FCT_AGG_CASH_FLOWS.N_INFLOW_AMT_RCY −
(FCT_AGG_CASH_FLOWS.N_INFLOW_AMT_RCY *
([ASSUM_PCT]/100))
ELSE
FCT_AGG_CASH_FLOWS.N_ADJ_INFLOW_AMT_RCY
END BP1,
CASE
WHEN DIM_PRODUCT.V_BALANCE_SHEET_CATEGORY IN
(‘LIABILITY’) THEN
FCT_AGG_CASH_FLOWS.N_OUTFLOW_AMT_RCY −
(FCT_AGG_CASH_FLOWS.N_OUTFLOW_AMT_RCY *
([ASSUM_PCT]/100))
ELSE
FCT_AGG_CASH_FLOWS.N_ADJ_OUTFLOW_AMT_RCY
END BP2,
‘Y’ BP3,
N_ADJ_INFLOW_AMT_RCY,
N_ADJ_OUTFLOW_AMT_RCY
FROM FCT_AGG_CASH_FLOWS,
DIM_PRODUCT,
DIM_ORG_STRUCTURE,
DIM_RESULT_BUCKET
WHERE FCT_AGG_CASH_FLOWS.N_PROD_SKEY =
DIM_PRODUCT.N_PROD_SKEY
AND FCT_AGG_CASH_FLOWS.N_ENTITY_SKEY =
DIM_ORG_STRUCTURE.N_ENTITY_SKEY
AND FCT_AGG_CASH_FLOWS.N_RESULT_BUCKET =
DIM_RESULT_BUCKET.N_RESULT_BUCKET) SRC
ON (TRGT.PK_COLS = SRC.PK_COLS)
WHEN MATCHED THEN
UPDATE
SET TRGT.N_ADJ_INFLOW_AMT_RCY = CASE WHEN
HIER_CODE IN (1, 2, 3)
THEN BP1
ELSE N_ADJ_INFLOW_AMT_RCY
END,
TRGT.N_ADJ_OUTFLOW_AMT_RCY = CASE WHEN
HIER_CODE IN (1, 2, 3)
THEN BP2
ELSE N_ADJ_OUTFLOW_AMT_RCY
END

Blocks 650, 655, 660, 640:

At block 650, a table identified as FSI_LRM_ASSUMPTION_TASKS is accessed to retrieve seeded tasks/rules (Pre-Offsetting Rule (block 655) and Post-Offsetting Rule (block 660)) for all the assumption categories and sub-categories that are defined with the assumptions.

The Pre-offsetting task/rule is a data transformation rule. The data transformation rule is an encapsulation of database sub-routine. This database sub-routine generates the resultant cash flows in the offset time bucket. The difference between the offsetting rule and this pre-offsetting rule is that in the case of pre-offsetting rule, the generated cash flows are either added to existing contractual cash flows (when the dimensional values of the assumption definition and contractual cash flow match) or generated as new cash flows whereas in case of offsetting rule, the contractual cash flows are reduced. Example coded is shown in Table 5.

```
TABLE 5
MERGE INTO FCT_AGG_CASH_FLOWS TRG USING
(WITH FA AS
  (SELECT OCR1.N_PK_SKEY N_STANDARD_PRODUCT_TYPE_SKEY,
  OCR2.N_PK_SKEY N_STANDARD_CUSTOMER_TYPE_SKEY,
  OCR3.V_PK_CODE F_BROKER_INVOLVED_FLAG,
  OCR4.N_PK_SKEY N_RESIDUAL_MATURITY_BAND_SKEY ,
  FAF.N_RESULT_BUCKET_SKEY,
  FAF.N_ALLOCATED_FACTOR_PERCENTAGE ,
  FAF.N_PENALTY_PERCENT,
  FAF.N_ASSUMPTION_PCT ,
  FAF.N_ASSUMPTION_PCT2,
  FAF.N_ASSUMPTION_LEG_NO
  FROM FSI_BAU_TB_ALLOCATION_FACTOR FAF
  INNER JOIN FSI_LRM_HIER_MEMBER_DETAILS OCR1
  ON OCR1.V_HIER_NODE=FAF.V_DIM_COL_1
  INNER JOIN FSI_LRM_HIER_MEMBER_DETAILS OCR2
  ON OCR2.V_HIER_NODE=FAF.V_DIM_COL_2
  INNER JOIN FSI_LRM_HIER_MEMBER_DETAILS OCR3
  ON OCR3.V_HIER_NODE=FAF.V_DIM_COL_3
  INNER JOIN FSI_LRM_HIER_MEMBER_DETAILS OCR4
  ON OCR4.V_HIER_NODE =FAF.V_DIM_COL_4
  WHERE FAF.N_ASSUMPTION_ID=229
  AND FAF.N_VERSION_NO =3
  )
SELECT TRG_TBL.N_COMPOSITE_SKEY AS N_AGG_CASH_FLOW_SKEY,
  TRG_TBL.N_RUN_SKEY,
  TRG_TBL.N_AS_OF_DATE_SKEY,
  DCT.N_CASH_FLOW_TYPE_SKEY,
  FA.N_RESULT_BUCKET_SKEY ,
  SUM(
  CASE
  WHEN dp.v_balance_sheet_category IN (‘ASSET’,‘OFF BALANCE SHEET’)
  THEN TRG_TBL.N_LESS_STABLE_AMT_RCY *
FA.N_ALLOCATED_FACTOR_PERCENTAGE*(FA.N_ASSUMPTION_PCT/100)
  ELSE 0
  END ) N_ADJ_INFLOW_AMT_RCY,
  SUM(
  CASE
  WHEN dp.v_balance_sheet_category IN (‘LIABILITY’)
  THEN TRG_TBL.N_LESS_STABLE_AMT_RCY *
FA.N_ALLOCATED_FACTOR_PERCENTAGE*(FA.N_ASSUMPTION_PCT/100)
  ELSE 0
  END ) N_ADJ_OUTFLOW_AMT_RCY
FROM FA
INNER JOIN FSI_LRM_INSTRUMENT TRG_TBL
```

| | |
|---|---|
| ON (TRG_TBL.F_BROKER_INVOLVED_FLAG | =FA.F_BROKER_INVOLVED_FLAG |

AND
TRG_TBL.N_RESIDUAL_MATURITY_BAND_SKEY=FA.N_RESIDUAL_MATURITY_BAND_SK
EY
AND
TRG_TBL.N_STANDARD_CUSTOMER_TYPE_SKEY=FA.N_STANDARD_CUSTOMER_TYPE_{—}
SKEY
AND TRG_TBL.N_STANDARD_PRODUCT_TYPE_SKEY
=FA.N_STANDARD_PRODUCT_TYPE_SKEY)
INNER JOIN DIM_PRODUCT DP

| | |
|---|---|
| ON TRG_TBL.N_PRODUCT_SKEY | = DP.N_PROD_SKEY |

AND DP.F_LATEST_RECORD_INDICATOR = ‘Y’
INNER JOIN DIM_CASH_FLOW_TYPE DCT

| | |
|---|---|
| ON 1 | =1 |

AND DCT.F_LATEST_RECORD_INDICATOR=‘Y’
AND DCT.V_CASH_FLOW_TYPE_CODE =‘P’

| | |
|---|---|
| WHERE TRG_TBL.N_RUN_SKEY | =<<run_skey>> |

```
AND TRG_TBL.N_AS_OF_DATE_SKEY =<<mis_date_skey>>
GROUP BY TRG_TBL.N_COMPOSITE_SKEY,
  TRG_TBL.N_RUN_SKEY,
  TRG_TBL.N_AS_OF_DATE_SKEY,
  DCT.N_CASH_FLOW_TYPE_SKEY,
  FA.N_RESULT_BUCKET_SKEY
) SRC ON ( TRG.N_AGG_CASH_FLOW_SKEY=SRC.N_AGG_CASH_FLOW_SKEY AND
```

TRG.N_CASH_FLOW_TYPE_SKEY=SRC.N_CASH_FLOW_TYPE_SKEY AND
TRG.N_RESULT_BUCKET_SKEY=SRC.N_RESULT_BUCKET_SKEY AND
TRG.N_AS_OF_DATE_SKEY = <<mis_date_skey>> AND
TRG.N_RUN_SKEY =<<run_skey>> )

```
WHEN MATCHED THEN
  UPDATE
  SET TRG.N_ADJ_OUTFLOW_AMT_RCY=SRC.N_ADJ_OUTFLOW_AMT_RCY,
  TRG.N_ADJ_INFLOW_AMT_RCY =SRC.N_ADJ_INFLOW_AMT_RCY
WHEN NOT MATCHED THEN
  INSERT
  (
```

N_AGG_CASH_FLOW_SKEY,
N_AS_OF_DATE_SKEY,
N_CASH_FLOW_TYPE_SKEY,
N_RESULT_BUCKET_SKEY,
N_RUN_SKEY,
N_ADJ_INFLOW_AMT_RCY,
N_ADJ_OUTFLOW_AMT_RCY

```
  )
  VALUES
  (
```

SRC.N_AGG_CASH_FLOW_SKEY ,
SRC.N_AS_OF_DATE_SKEY ,
SRC.N_CASH_FLOW_TYPE_SKEY ,
SRC.N_RESULT_BUCKET_SKEY ,
SRC.N_RUN_SKEY,
SRC.N_ADJ_INFLOW_AMT_RCY,
SRC.N_ADJ_OUTFLOW_AMT_RCY

)

The Post-offsetting rule generated at block 660: In the an application run definition window (such as a Liquidity Risk Management Run Definition window), assumptions can either be “Applied To” Changing Balance/Cash Flows or Original Balance/Cash Flows. This calculation is applied across business assumptions in a single Run. The calculation is applicable across business assumptions based on the option selected as part of the Assumption Applied To field in the Run Definition window. This means that the selected assumptions are executed sequentially and the effects of the previous assumption are taken into account if the Changing Balance/Cash Flows option is selected in the Run Definition window.

In case Option Changing Balance/Cash Flows, this rule updates the amount in (n_adj_inflow_amt_rcy/n_adj_outflow_amt_rcy) adjusted cash inflows/outflows column (generated cash flow amount) is updated back into original cash flow amount (fct_agg_cash_flows.n_inflow_amt_rcy/fct_agg_cash_flows.n_outflow_amt_rcy) so that the next assumption takes the amount as the base amount.

Block 645:

At block 645, the assumption engine creates a run rule framework RRF process. For example, when an assumption is approved, an RRF process is registered with three tasks: the pre-offsetting rule (database transformation), offsetting rule, and post-offsetting rule. The process is executed when an assumption is selected for execution (e.g. in a run management application). The method then stops at 670.

Stress Testing

In another embodiment, the assumption engine 115 includes a Stress Testing module configured to execute Stress Runs. Stress runs are executed by selecting a baseline Run that is, the LRM BAU Run in a Stress Definition screen and replacing the business as usual (BAU) assumptions which are part of the baseline Run with stress business assumptions. Stress assumptions are business assumptions with adverse values and are defined as part of the assumption input screens (FIG. 3-4). The replacement of BAU assumptions with the stress assumptions constitutes the stress scenario. Once defined and saved, the Stress Run can be viewed, approved and executed from the Run Management screen of LRM.

The Stress Run defined appears in a list of Runs in a Run Management Summary window on the graphical user interface screen 300. A user can approve the definition and then execute it. In one embodiment, a BAU Run is a pre-requisite for defining stress Runs.

On execution, the stress assumptions are applied to the data records of the contract cash flows to assess the impact of the adverse scenario on the liquidity position of the organization. An output data structure/records (time buckets 125) is generated with the resulting cash flow values. Liquidity metrics are then determined and generated (output 145) based on the resulting cash flow values.

Cloud or Enterprise Embodiments

In one embodiment, the system 100 (FIG. 1) is a computing/data processing system including the assumption engine 115 that is an executable application or collection of distributed applications in an enterprise. The assumption engine 115 is an implemented component/program module of the application. The application and computing system 100 may be configured to operate with or be implemented as a cloud-based networking system, a software as a service (SaaS) architecture, or other type of networked computing solution. In one embodiment the present system 100 is a centralized server-side application that provides at least the functions disclosed herein and that is accessed by many users via computing devices/terminals communicating with the computing system (functioning as the server) over a computer network.

In one embodiment, one or more of the components described herein (including the assumption engine 115) are configured as program modules stored in a non-transitory computer readable medium. The program modules are configured with stored instructions that when executed by at least a processor cause the computing device 100 to perform the corresponding function(s) as described herein.

Computing Device Embodiment

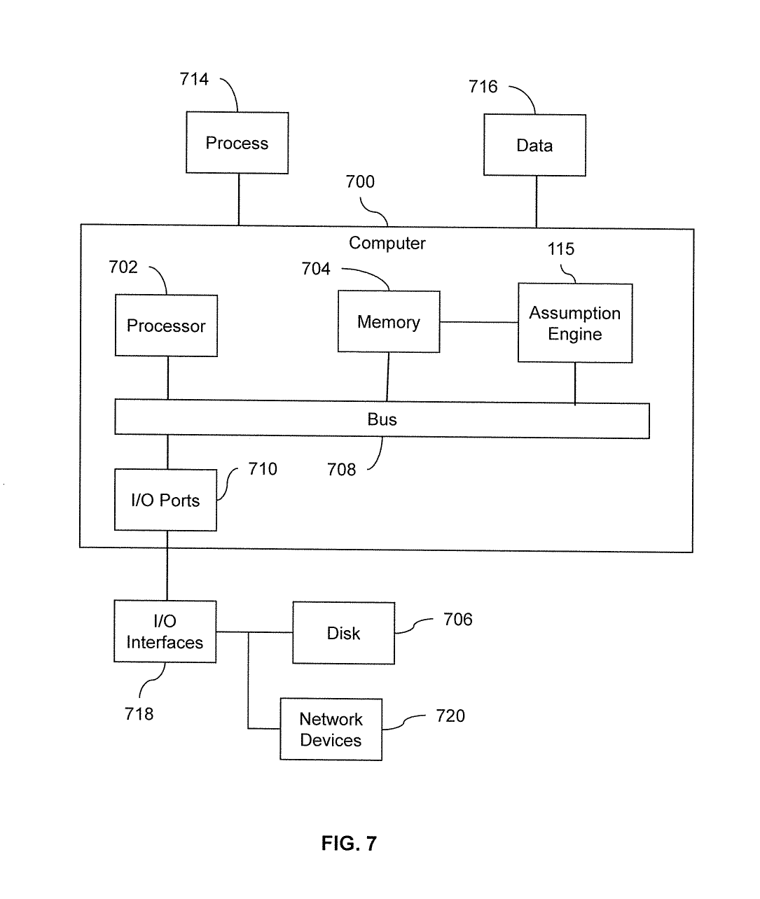

FIG. 7 illustrates an example computing device 700 that is configured and/or programmed with one or more of the example systems and methods described herein, and/or equivalents. The example computing device may be a computer 700 that includes a processor 702, a memory 704, and input/output ports 710 operably connected by a bus 708. In one example, the computer 700 includes the assumption engine 115 (from FIG. 1) configured to facilitate the functions as previous described including the GUI 120 and the algorithms of FIGS. 2, 5, and/or 6. In different embodiments, the assumption engine 115 may be implemented in the processor 702, stored in memory 704, or stored in disk 706.

In one embodiment, assumption engine 115 or the computer 700 is a means (e.g., structure: hardware, non-transitory computer-readable medium, algorithm) for performing the actions described. In some embodiments, the computing device 700 may be a server operating in a cloud computing system, a server configured in a Software as a Service (SaaS) architecture, a smart phone, laptop, tablet computing device, and so on.

The means may also be implemented as stored computer executable instructions that are presented to computer 700 as data 716 that are temporarily stored in memory 704 and then executed by processor 702.

Generally describing an example configuration of the computer 700, the processor 702 may be a variety of various processors including dual microprocessor and other multi-processor architectures. A memory 704 may include volatile memory and/or non-volatile memory. Non-volatile memory may include, for example, ROM, PROM, and so on. Volatile memory may include, for example, RAM, SRAM, DRAM, and so on.

A storage disk 706 may be operably connected to the computer 700 via, for example, an input/output (I/O) interface (e.g., card, device) 718 and an input/output port 710. The disk 706 may be, for example, a magnetic disk drive, a solid state disk drive, a floppy disk drive, a Zip drive, a flash memory card, a memory stick, and so on. Furthermore, the disk 706 may be a CD-ROM drive, a CD-R drive, a CD-RW drive, a DVD ROM, and so on. The memory 704 can store a process 714 and/or a data 716, for example. The disk 706 and/or the memory 704 can store an operating system that controls and allocates resources of the computer 700.

The computer 700 may interact with input/output (I/O) devices via the I/O interfaces 718 and the input/output ports 710. Input/output devices may be, for example, a keyboard, a microphone, a pointing and selection device, cameras, video cards, displays, the disk 706, the network devices 720, and so on. The input/output ports 710 may include, for example, serial ports, parallel ports, and USB ports.

The computer 700 can operate in a network environment and thus may be connected to the network devices 720 via the I/O interfaces 718, and/or the I/O ports 710. Through the network devices 720, the computer 700 may interact with a network. Through the network, the computer 700 may be logically connected to remote computers. Networks with which the computer 700 may interact include, but are not limited to, a LAN, a WAN, and other networks.

### DEFINITIONS AND OTHER EMBODIMENTS

In another embodiment, the described components, functions, methods and/or their equivalents are implemented with computer executable instructions stored in a memory. Thus, in one embodiment, a non-transitory computer readable/storage medium is configured with stored computer executable instructions of an algorithm/executable application that when executed by a machine(s) cause the machine(s) (and/or associated components) to perform the associated functions. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

Unless specifically stated otherwise, it is appreciated that throughout the description, discussions using terms such as “processing”, “computing”, “calculating”, “determining”, “displaying”, “defining”, “applying”, “identifying”, “matching”, or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed by a processor. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. For example, the assumption engine 115 is implemented in logic in one embodiment.

Equivalent logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”.

What is claimed is:

1. A computing system comprising:
an input/output port for transmitting and receiving network communications;
a memory including instructions stored therein; and
a processor electrically connected with the input/output port and with the memory, wherein the processor is configured to execute the instructions from the memory and when the instructions are executed, cause the processor to:
generate data records of a resource, using at least the processor of the computer, from a set of contracts that define usage terms for the resource, wherein the data records include quantity levels of the resource that are available in a plurality of time intervals;
allocate the plurality of time intervals to a plurality of time buckets defined in a data structure, wherein each time bucket stores an associated quantity level of the resource that is expected in the time interval associated with the time bucket based on the set of contracts;
define a set of possible events that cause changes to the quantity levels of the resource in one or more of the time intervals;
apply the set of possible events to the data records where the set of possible events change the quantity level of the resource available by adding or removing an amount from the quantity level in the plurality of time buckets, and generate modified quantity levels in one or more of the time buckets; and
generate a computerized output including a liquidity metric based on, at least in part, the modified quantity levels as a result of applying the set of possible events, wherein the computerized output represents an available quantity level of the resource during the plurality of time intervals; and
transmit the computerized output via the input/output port to a computer component.

2. The computing system of claim 1, wherein the instructions for generating the data records of the resource from the set of contracts includes instructions that when executed by the processor cause the processor to:
generate cash flow data records, using at least the processor of the computer, from a set of financial contracts that define terms of cash inflow and cash outflow at time periods, wherein the cash flow data records include expected cash flow values that are allocated to the time buckets based on the terms of the cash inflow and the cash outflow of the set of financial contracts; and
wherein the set of possible events are a set of assumptions that cause changes to the cash flow data records; and
wherein applying the set of possible events includes applying the set of business assumptions to the cash flow data records and generating modified cash flow values in one or more of the time buckets; and
generating and outputting liquidity metrics from the modified cash flow values as a result of applying the set of business assumptions.

3. The computing system of claim 2, further comprising instructions that when executed by the processor cause the processor to:
generate a graphical user interface that includes a plurality of parameters for defining an assumption from the set of assumptions for causing a change to the cash flow data records; and
display the graphical user interface on a display screen, wherein the plurality of parameters include input fields for defining the plurality of parameters.

4. The computing system of claim 2, wherein defining the set of assumptions includes instructions that when executed by the processor cause the processor to: define a first assumption comprising identifying an assumption category and an assumption sub-category that define parameters of the first assumption.

5. The computing system of claim 2, further comprising instructions stored in the memory that when executed by the processor cause the processor to:
display a graphical user interface that allows selection of a time bucket for application of the set of assumptions.

6. The computing system of claim 2, further comprising instructions stored in the memory that when executed by the processor cause the processor to:
store the set of assumptions in a library of assumptions in a database; and
wherein one or more assumptions from the set of assumptions are selectable from the library of assumptions to be applied to the cash flow data records.

7. A computer-implemented method performed by a computing device where the computing device includes at least a processor for executing instructions from a memory, the method comprising:
generating data records of a resource, using at least the processor of the computer, from a set of contracts that define usage terms for the resource, wherein the data records include quantity levels of the resource that are available in a plurality of time intervals;
allocating the plurality of time intervals to a plurality of time buckets defined in a data structure, wherein each time bucket stores an associated quantity level of the resource that is expected in the time interval associated with the time bucket based on the set of contracts;
defining a set of possible events that cause changes to the quantity levels of the resource in one or more of the time intervals;
applying the set of possible events to the data records where the set of possible events change the quantity level of the resource available by adding or removing an amount from the quantity level in the plurality of time buckets, and generating modified quantity levels in one or more of the time buckets; and
generating a computerized output including a liquidity metric based on, at least in part, the modified quantity levels as a result of applying the set of possible events, wherein the computerized output represents an available quantity level of the resource during the plurality of time intervals; and
transmitting the computerized output via a network communication to a computer component.

8. The computer-implemented method of claim 7, wherein generating the data records of the resource from the set of contracts includes generating cash flow data records, using at least the processor of the computer, from a set of financial contracts that define terms of cash inflow and cash outflow at time periods, wherein the cash flow data records include expected cash flow values that are allocated to the time buckets based on the terms of the cash inflow and the cash outflow of the set of financial contracts; and
wherein defining the set of possible events include defining a set of assumptions that cause changes to the cash flow data records;
wherein applying the set of possible events includes applying the set of business assumptions to the cash flow data records and generating modified cash flow values in one or more of the time buckets; and
generating and outputting liquidity metrics from the modified cash flow values as a result of applying the set of business assumptions.

9. The computer-implemented method of claim 8, further comprising:
generating a graphical user interface that includes a plurality of parameters for defining an assumption from the set of assumptions for causing a change to the cash flow data records;
displaying the graphical user interface on a display screen, wherein the plurality of parameters include input fields for defining the plurality of parameters.

10. The computer-implemented method of claim 8, wherein defining the set of assumptions includes defining a first assumption comprising identifying an assumption category and an assumption sub-category that define parameters of the first assumption.

11. The computer-implemented method of claim 8, further comprising:
Displaying a graphical user interface that allows selection of a time bucket for application of the set of assumptions.

12. The computer-implemented method of claim 8, further comprising:
storing the set of assumptions in a library of assumptions in a database; and
wherein one or more assumptions from the set of assumptions are selectable from the library of assumptions to be applied to the cash flow data records.

13. A non-transitory computer storage medium that stores instructions that when executed by a processor of a computing device, cause the processor to:
generate data records of a resource, using at least the processor of the computer, from a set of contracts that define usage terms for the resource, wherein the data records include quantity levels of the resource that are available in a plurality of time intervals;
allocate the plurality of time intervals to a plurality of time buckets defined in a data structure, wherein each time bucket stores an associated quantity level of the resource that is expected in the time interval associated with the time bucket based on the set of contracts;
define a set of possible events that cause changes to the quantity levels of the resource in one or more of the time intervals;
apply the set of possible events to the data records where the set of possible events change the quantity level of the resource available by adding or removing an amount from the quantity level in the plurality of time buckets, and generate modified quantity levels in one or more of the time buckets; and
generate a computerized output including a liquidity metric based on, at least in part, the modified quantity levels as a result of applying the set of possible events, wherein the computerized output represents an available quantity level of the resource during the plurality of time intervals; and
transmit the computerized output via a network communication to a computer component.

14. The non-transitory computer storage medium of claim 13, wherein the instructions for generating the data records of the resource from the set of contracts includes instructions that when executed by the processor cause the processor to:
generate cash flow data records, using at least the processor of the computer, from a set of financial contracts that define terms of cash inflow and cash outflow at time periods, wherein the cash flow data records include expected cash flow values that are allocated to the time buckets based on the terms of the cash inflow and the cash outflow of the set of financial contracts; and
wherein the set of possible events are a set of assumptions that cause changes to the cash flow data records; and
wherein applying the set of possible events includes applying the set of business assumptions to the cash flow data records and generating modified cash flow values in one or more of the time buckets; and
generating and outputting liquidity metrics from the modified cash flow values as a result of applying the set of business assumptions.

15. The non-transitory computer storage medium of claim 14, further comprising instructions that when executed by the processor cause the processor to:
generate a graphical user interface that includes a plurality of parameters for defining an assumption from the set of assumptions for causing a change to the cash flow data records; and
display the graphical user interface on a display screen, wherein the plurality of parameters include input fields for defining the plurality of parameters.

16. The non-transitory computer storage medium of claim 14, wherein defining the set of assumptions includes instructions that when executed by the processor cause the processor to: define a first assumption comprising identifying an assumption category and an assumption sub-category that define parameters of the first assumption.

17. The non-transitory computer storage medium of claim 14, further comprising instructions that when executed by the processor cause the processor to:
display a graphical user interface that allows selection of a time bucket for application of the set of assumptions.

18. The non-transitory computer storage medium of claim 14, further comprising instructions that when executed by the processor cause the processor to:
store the set of assumptions in a library of assumptions in a database; and
wherein one or more assumptions from the set of assumptions are selectable from the library of assumptions to be applied to the cash flow data records.
